(19) United States
(12) Patent Application Publication
(10) Pub. No.: US 2006/0130083 A1
(43) Pub. Date: Jun. 15, 2006

(54) Shockproof locking assembly device

(76) Inventor: Chun-Yi Cheng, Taipei (TW)

Correspondence Address: RABIN & Berdo, PC, 1101 14TH STREET, NW, SUITE 500, WASHINGTON, DC, 20005, US

(21) Appl. No.: 11/290,493

(22) Filed: Dec. 1, 2005

(30) Foreign Application Priority Data
Dec. 10, 2004 (TW) 93138417

(51) Int. Cl. G11B 33/08; G11B 33/14

(52) U.S. Cl. 720/651

(57) ABSTRACT

A shockproof locking assembly device including a hole, a slot and a vibration absorbing locking device is provided. The vibration absorbing locking device includes a locking element and a vibration absorbing element. The locking element includes a head portion and a shaft portion. The shaft portion extends from the head portion for locking into the hole. The vibration absorbing element encompasses part of the locking element for the shaft portion to penetrate the vibration absorbing element. The vibration absorbing element penetrates the slot.

This application claims the benefit of Taiwan application Serial No. 93138417, filed Dec. 10, 2004, the subject matter of which is incorporated herein by reference.

### BACKGROUND OF THE INVENTION

1. Field of the Invention

The invention relates in general to a locking device, and more particularly to a locking assembly device which incorporates a first housing and a second housing and prevents the occurrence of vibration when the first housing and the second housing receive an external force.

2. Description of the Related Art

With the rapid advance and change in technology, computer has become an indispensable tool to modern people in their everyday life. An ordinary computer at least includes a host, a monitor, a keyboard and a mouse. The monitor, the keyboard and the mouse are coupled to the host. The host includes a computer housing, a motherboard, a central processing unit (CPU), a memory, a display card, a hard disc (HD) and an optical disc drive (ODD). The motherboard, the CPU, the memory, the display card, the hard disc and the optical disc drive are all disposed within computer housing. The CPU, the memory, the display card, the hard disc and the optical disc drive are coupled to the motherboard via a cable line or an electrical socket on the motherboard.

In order to firmly secure the hard disc and the optical disc drive, the user would secure the hard disc and the optical disc drive on the computer housing by several screws which pass through several via holes of the computer housing to be secured at the screw holes on the housing of the hard disc or the optical disc drive. However, when the hard disc, the optical disc drive or the screw receive an external force, the screw and screw hole will be loosened, largely reducing the tightness between the screw and the screw hole. Consequently, the hard disc or the optical disc drive would vibrate when operating or receiving an external force, severely affecting the operation quality of the hard disc or the optical disc drive. Besides, the user needs to use a screw driver to screw or loosen the screws when mounting the hard disc or the optical disc drive on or dismounting it from the computer housing. The whole process of assembling and disassembling of the hard disc or the optical disc drive is very time consuming. When screwing or loosening a screw, if the force is applied properly, the recess of the screw might be damaged, resulting in a slipped screw causing more difficulties in assembly and disassembly.

### SUMMARY OF THE INVENTION

It is therefore the object of the invention to provide a shockproof locking assembly device. The incorporation of the slot, the hole and the vibration absorbing locking device not only enables a first housing having the hole to be coupled to and slide with respect to a second housing having the slot, but also prevents the first housing and the second housing from vibrating when receiving an external force. Thus, the assembly time of the first housing and the second housing is reduced, and the tightness and shockproof between the first housing and the second housing are largely enhanced. Besides, the design of intruding a positioning element to the locking assembly device of the embodiment presses the vibration absorbing locking device at one end of the slot so that the first housing and the second housing are correspondingly positioned and secured accordingly.

According to an object of the invention, a shockproof locking assembly device including a hole, a slot and a vibration absorbing locking device is provided. The vibration absorbing locking device includes a locking element and a vibration absorbing element. The locking element includes a head portion and a shaft portion. The shaft portion extends from the head portion for locking into the hole. The vibration absorbing element encompasses part of the locking element for the shaft portion to penetrate the vibration absorbing element. The vibration absorbing element penetrates the slot.

According to another object of the invention, a vibration absorbing element mounted on a locking element is provided. The locking element includes a head portion and a shaft portion. The head portion has a first surface and a second surface opposite to each other. An end of the shaft portion is connected to part of the second surface. The vibration absorbing element includes a bottom portion, a top portion and a vertical portion. The bottom portion having a bottom aperture is for receiving the end of the shaft portion for most part of the shaft portion to be projected from the bottom portion. The top portion having a top aperture for exposing part of the first surface. The vertical portion has a chamfer being adjacent to the bottom aperture and the top aperture. The vertical portion is for connecting the bottom portion and the top portion. The chamfer is for receiving the head portion.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is cross-sectional view of a vibration absorbing locking device according to a first embodiment of the invention;

FIG. 1B is a 3-D diagram of a vibration absorbing locking device according to a first embodiment of the invention;

FIG. 1C is a top view of a vibration absorbing locking device having an I-shaped recess of FIG. 1A;

FIG. 1D is a top view of a vibration absorbing locking device having a cross-shaped recess of FIG. 1A;

FIG. 2 is a sectional view of the assembly of a vibration absorbing locking device and a first housing of FIG. 1A;

FIGS. 3A-3B are two exploded diagrams of an electronic device having a locking assembly device according to a second embodiment of the invention;

FIG. 4 is a partially enlarged cross-sectional view of a first housing of FIG. 3A coupled with a second housing via locking assembly device using xz-plane as the sectional plane and viewed from y-direction;

FIG. 5A is a 3-D diagram of the assembly of an electronic device having a locking assembly device of FIG. 3A;

FIG. 5B is a 3-D assembly diagram of an electronic device having a locking assembly device of FIG. 3B;

FIG. 6A is a right side view of an electronic device having a locking assembly device of FIG. 5A;

FIG. 6B is a left side view of an electronic device having a locking assembly device of FIG. 5B;

FIGS. 7A-7B are two partially enlarged cross-sectional views of an electronic device having a locking assembly device according to a third embodiment of the invention; and

FIGS. 8A-8B are two partially enlarged cross-sectional views of an electronic device having a locking assembly device according to a fourth embodiment of the invention.

### DETAILED DESCRIPTION OF THE INVENTION

### First Embodiment

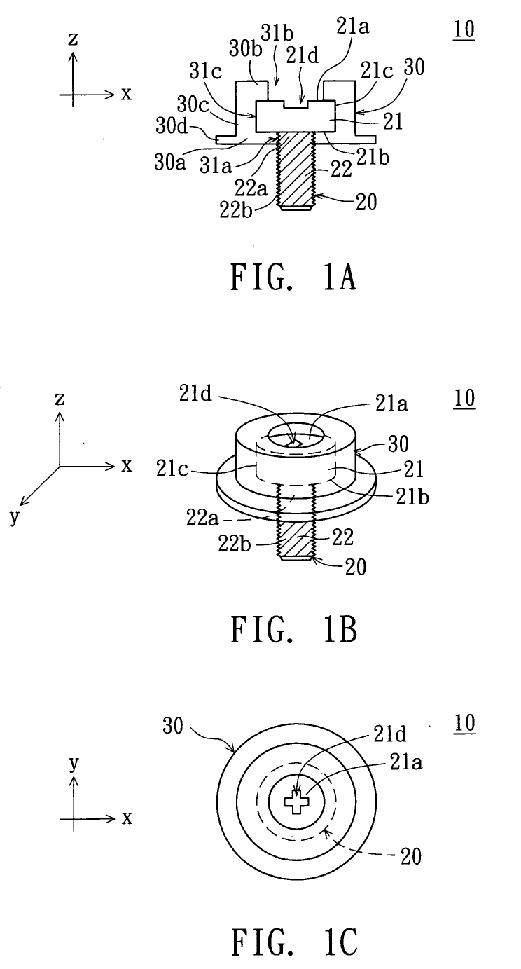

Referring to FIG. 1A˜1B, FIG. 1A is a cross-sectional view of a vibration absorbing locking device according to a first embodiment of the invention, while FIG. 1B is a 3-D diagram of a vibration absorbing locking device according to a first embodiment of the invention. In FIG. 1A˜1B, the vibration absorbing locking device 10 includes a locking element 20 and a vibration absorbing element 30. The locking element 20 includes a head portion 21 and a shaft portion 22. The head portion 21 has a first surface 21a and a second surface 21b opposite to each other, and a lateral side 21c connected to the first surface 21a and the second surface 21b. The shaft portion 22 has a first end 22a and a second end 22b. The first end 22a is connected to part of the second surface 21b. That is to say, the shaft portion 22 extends from the head portion 21. Besides, the head portion 21 and the shaft portion 22 can be integrally formed into an integral body. The vibration absorbing element 30 is mounted on the locking element 20 and cover part of the head portion 21 and the first end 22a for exposing part of the first surface 21a and most part of the shaft portion 22 including the second end 22b. Besides, the vibration absorbing element 30 includes a shock absorbing material such as rubber, plastics or polymer for instance.

Furthermore, the vibration absorbing element 30 includes a bottom portion 30a, a top portion 30b, a vertical portion 30c and a rib portion 30d. The bottom portion 30a has a bottom aperture 31a. The bottom aperture 31a is for receiving the first end 22a of the shaft portion 22 and for most part of the shaft portion 22 including the second end 22b to be projected from the bottom portion 30a. The top portion 30b has a top aperture 31b for exposing part of the first surface 21a. The vertical portion 30c, which is connected to the bottom portion 30a and the top portion 30b, has a chamfer 31c connected to the bottom aperture 31a and the top aperture 31b. The chamfer 31c is for receiving the head portion 21. The rib portion 30d encompasses the bottom portion 30a and is disposed on a peripheral lateral side of the bottom portion 30a, so that the vibration absorbing element 30 encompasses part of the locking element 20 for the shaft portion 22 to penetrate the vibration absorbing element 30. Besides, the bottom portion 30a, the top portion 30b, the vertical portion 30c and the rib portion 30d are integrally formed into an integral body. In the present embodiment of the invention, the peripheral lateral side of the bottom portion 30a, that of the top portion 30b and that of the vertical portion 30c are coplanar, the rib portion 30d is projected from the peripheral lateral side of the bottom portion 30a and encompasses the bottom portion 30a. The thickness of the rib portion 30d along the z-direction can be equal to or smaller than the thickness of the bottom portion 30a along the z-direction.

As shown in FIG. 1B, in the present embodiment of the invention, the vibration absorbing element 30 is a circular hollowed structure, the head portion 21 can be a cylinder structure, and the shaft portion 22 can be round rod structure for instance. In the present embodiment of the invention, the shape and structure of the vibration absorbing element 30, the head portion 21 and the shaft portion 22 are not limited thereto. For example, the head portion 21 can be an oval-shaped or a polygonal column structure for instance.

As shown in FIGS. 1A˜1B, the first surface 21a further has a recess 21d for a screw driver to be received and positioned, so that the locking element 20 can locked into or loosen from a screw hole. As shown in FIG. 1C, the recess 21d can be a cross-shaped recess into which a cross-shaped screw driver can be inserted and positioned. As shown in FIG. 1D, the recess 21d can be an I-shaped recess into which an I-shaped screw driver can be inserted and positioned. In the present embodiment of the invention, the shaft portion 22 is connected to the central region of the second surface 21 b of the head portion 21, the vibration absorbing element 30 covers the peripheral region of the first surface 21a, the lateral side 21c and part of the peripheral region of the second surface 21b but exposes the central region of the first surface 21a and most part of the shaft portion 22. In the present embodiment of the invention, the vibration absorbing element 30 can cover the locking element 20 as long as most part of the shaft portion 22 including the second end 22b can be screwed into a hole and that the user can insert a screw driver into the recess 21d on the first surface 21a to rotate the locking element 20.

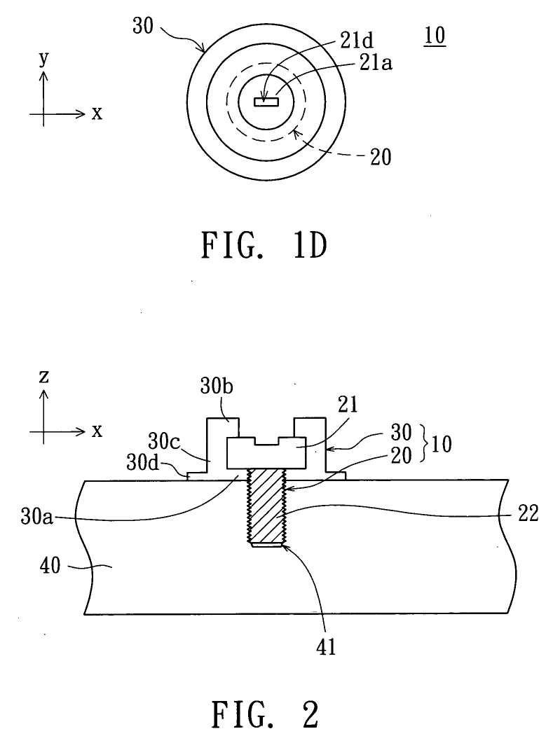

Referring to FIG. 2, a sectional view of the assembly of a vibration absorbing locking device and a first housing of FIG. 1A is shown. In FIG. 2, the user can use a screw driver to lock the shaft portion 22 of the vibration absorbing locking device 10 into a hole 41 of a first housing 40, so that the shaft portion 22 is secured at the hole 41 and the vibration absorbing locking device 10 is projected from the surface of the first housing 40. Thus, the bottom surface of the bottom portion 30a and that of the rib portion 30d contact the surface of the first housing 40, and part of the bottom portion 30a is positioned between the head portion 21 and the first housing 40. Besides, the first housing 40 can be a hard disc housing or an optical disc drive housing for instance.

When the vibration absorbing locking device 10 receives an external force, the vibration absorbing element 30 is capable of reducing the vibration of the vibration absorbing locking device 10 caused by the external force. It is not only to prevent the looseness between the locking element 20 and the hole 41, but also maintain the tightness between the locking element 20 and the first housing 40.

When the first housing 40 receives an external force, the vibration absorbing element 30, which contacts with the first housing 40, is capable of reducing the vibration of the first housing 40 when receives the external force. It is not only to prevent the looseness between the locking element 20 and the hole 41, but also maintain the tightness between the locking element 20 and the first housing 40.

### Second Embodiment

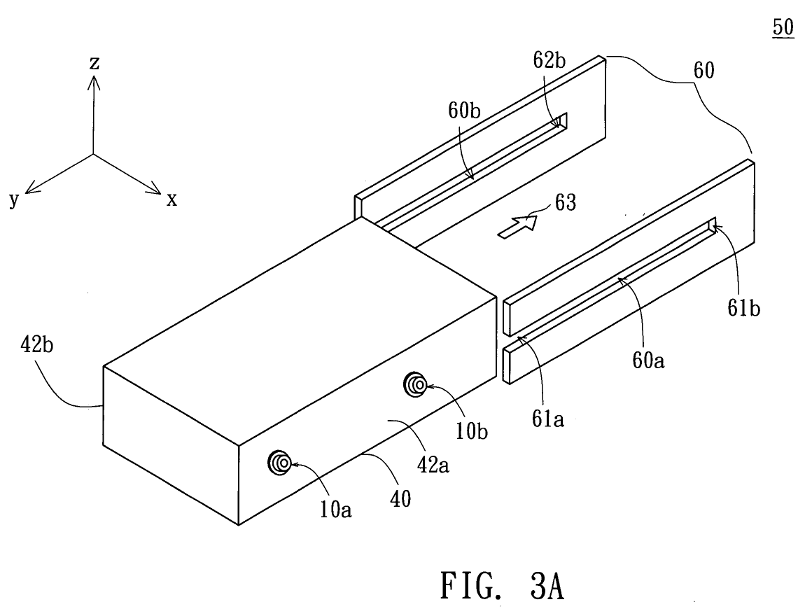

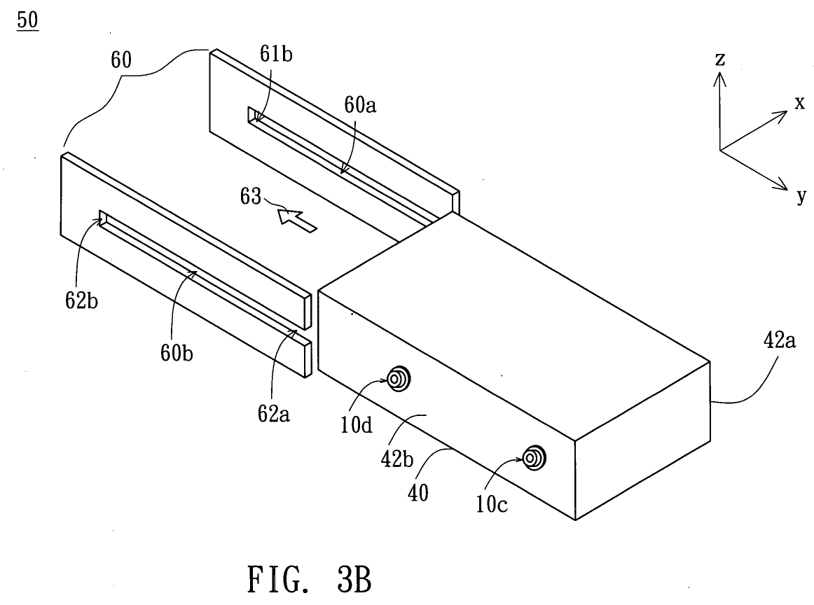

Referring to FIGS. 3A˜3B, two exploded diagrams of an electronic device having a locking assembly device according to a second embodiment of the invention are shown. In FIGS. 3A-3B, the electronic device 50 includes a first housing 40 described in the first embodiment, a second housing 60 and at least a vibration absorbing locking device 10 described in the first embodiment, such as four vibration absorbing locking devices 10a˜10d. The structure of the vibration absorbing locking devices 10a-10d, being the same with the vibration absorbing locking device 10 of the first embodiment, is not repeated here. The first housing 40 has a first lateral side 42a and a second lateral side 42b opposite to each other. The vibration absorbing locking devices 10a and 10b are correspondingly locked into two holes of the first housing 40 to be projected from the first lateral side 42a, while the vibration absorbing locking devices 10c and 10d are correspondingly locked into another two holes of the first housing 40 to be projected from the second lateral side 42b. The second housing 60 has at least a slot, such as the first slot 60a and the second slot 60b at two separated part of the second housing 60 for instance. The first slot 60a and the second slot 60b extend along the y-direction. The first slot 60a has a first entrance/exit 61a and a first slot end 61b, while the second slot 60b has a second entrance/exit 62a and a second slot end 62b. The first housing 40 can be a hard disc housing or a optical disc drive housing, the second housing 60 is a computer housing, and the electronic device 50 is a computer for instance.

The vibration absorbing locking devices 10a and 10b can slide into the first slot 60a along the direction of the arrow 63 from the first entrance/exit 61a, and the vibration absorbing locking device 10c and 10d can slide into the second slot 60b along the direction of the arrow 63 from the second entrance/exit 62a, so that the first housing 40 is coupled to and slides with respect to the second housing 60 via the vibration absorbing locking devices 10a˜10d. The slot width of the first slot 60a and that of the second slot 60b along the z-direction have to be smaller than or equal to the maximum thickness of the vertical portion 10c of the vibration absorbing locking devices 10a˜10d along the z-direction. Thus, the vertical portion of the vibration absorbing locking devices 10a˜10d along the z-direction can touch correspondingly the two parallel slot walls of the first slot 60a and the second the slot 60b parallel to the y-direction.

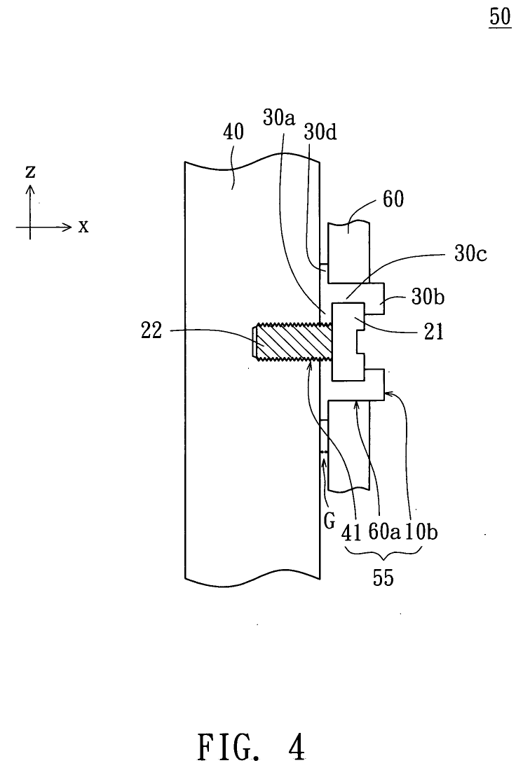

When the user would like to assemble the first housing 40 and the second housing 60, first of all, the user correspondingly slides the vibration absorbing locking devices 10a˜10d disposed in the first housing 40 into the first slot 60a and the second slot 60b along the direction of the arrow 63 (such as the y-direction), so that the first housing 40 is coupled to and slides with respect to the second housing 60 via the vibration absorbing locking devices 10a˜10d. The vertical portions of the vibration absorbing locking devices 10a˜10d along the z-direction correspondingly touch two parallel slot walls of the first slot 60a and the second slot 60b parallel to the y-direction, and the vibration absorbing locking devices 10a˜10d are correspondingly projected from the first slot 60a and the second slot 60b. As shown in FIG. 4, the distance between the top surface of the top portion 30b and that of the bottom portion 30a is larger than the thickness of the second housing 60 along the x-direction. Besides, the rib portion 30d can provide a buffer gap G between the first housing 40 and the second housing 60 to avoid the friction which arises when the first housing 40 is coupled to and slides with respect to the second housing 60 via the vibration absorbing locking devices 10a˜10d.

In the present embodiment of the invention, a locking assembly device 55 comprising the hole 41, the first slot 60a and the vibration absorbing locking device 10b is formed between the first housing 40 and the second housing 60. Apart from coupling the first housing 40 and the second housing 60, the locking assembly device 55 further prevents the first housing 40 and the second housing. 60 from vibrating when receiving an external force.

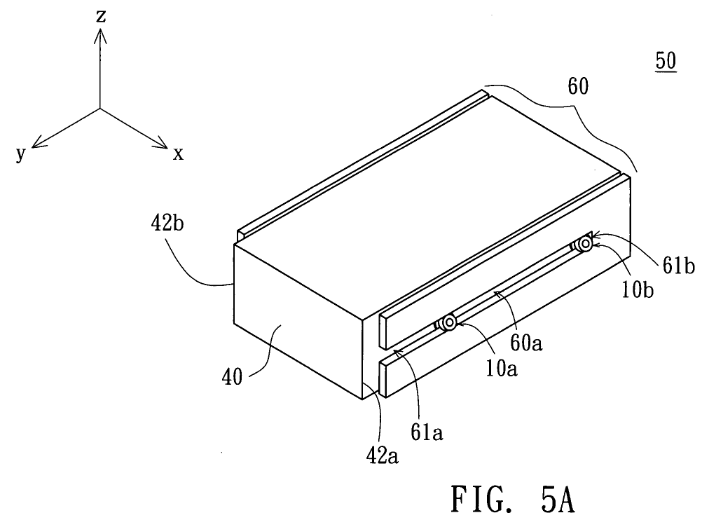

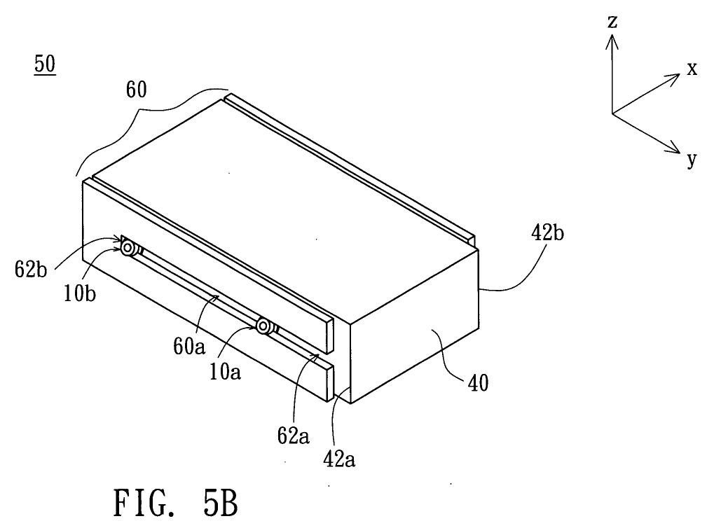

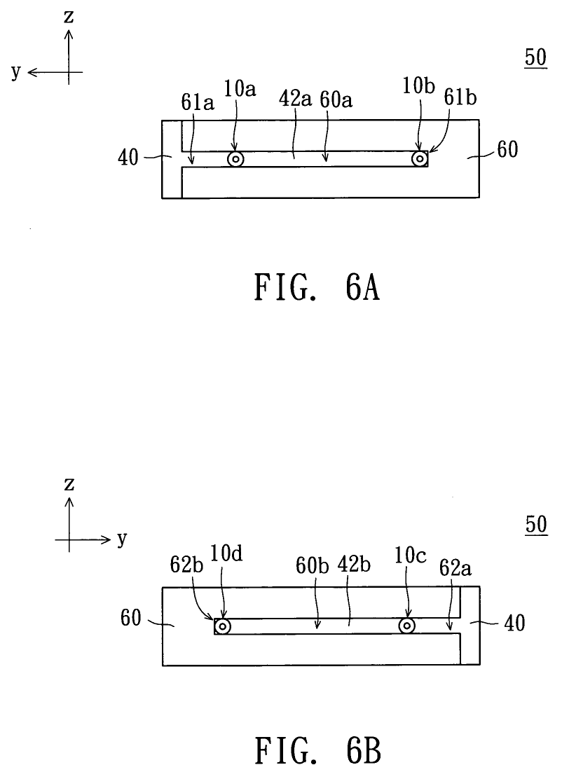

Next, as shown in FIG. 1A and FIGS. 5A˜6B, the user continues to move the first housing 40 along the direction of arrow 63 until the vibration absorbing locking devices 10b and 10d respectively reach the first slot end 61b and the second slot end 62b. Thus, the first housing 40 is coupled with the second housing 60.

When the vibration absorbing locking device 10a˜10d receives an external force, the vibration absorbing element 30 is capable of reducing the vibration of the vibration absorbing locking devices 10a˜10d to prevent the looseness between the locking element 20 and the hole of the first housing 40. Thus, the tightness between the locking element 20 and the first housing 40 is maintained, and the tightness and shockproof between the first housing 40 and the second housing 60 are further enhanced

When the first housing 40 or the second housing 60 receive an external force, the vibration absorbing element 30, which contacts with the first housing 40 or the second housing 60, is capable of reducing the vibration of the first housing 40 or the second housing 60 to prevent the looseness between the locking element 20 and the hole of the first housing 40. Thus, the tightness between the locking element 20 and the first housing 40 is maintained, and the tightness and shockproof between the first housing 40 and the second housing 60 are further enhanced.

### Third Embodiment

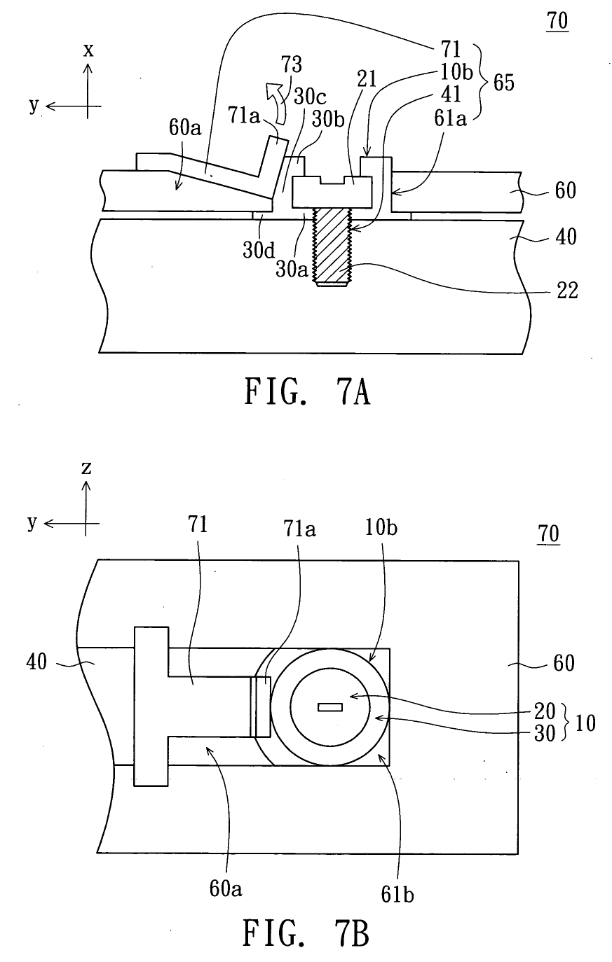

Referring to FIGS. 7A-7B, two partially enlarged cross-sectional views of an electronic device having a locking assembly device according to a fourth embodiment of the invention are shown. The electronic device 70 of the present embodiment differs with the electronic device 50 of the second embodiment in that a locking assembly device 65 having an extra positioning element 71 differs with the locking assembly device 55 of the second embodiment. As for other components which are the same in the two embodiments, the same labels are used and are not repeated here. In FIGS. 7A˜7B, one end of the positioning element 71 is connected to the second housing 60 while another end of the positioning element 71 extends towards the first slot end 61 b along the extending direction of the first slot 60a and tilts towards the first slot 60a. When the vibration absorbing locking device 10b slides to the first slot end 61b, another end of the positioning element 71 is for pressing the vibration absorbing locking device 10b at the first slot end 61b, such as pressing the top portion 30b and the vertical portion 30c for instance, so that the first housing 40 and the second housing 60 are correspondingly positioned and coupled together.

In the present embodiment of the invention, apart from coupling the first housing 40 and the second housing 60 and preventing the first housing 40 and the second housing 60 from vibrating when receiving an external force, the locking assembly device 65 can further enable the first housing 40 and the second housing 60 to be correspondingly positioned when the positioning element 71 presses the vibration absorbing locking device 10b at the first slot end 61b.

Besides, the positioning element 71 can be a bendable material, a spring, an elastic piece or a combination of a spring and an elastic piece for instance. Furthermore, the positioning element 71 and the second housing 60 can be integrally formed into an integral body. Another end of the positioning element 71, which can be a bending 71a for instance, is convenient for the user to grab at hand and apply a force along the direction of the arrow 73 to move and separate the positioning element 71 from the vibration absorbing locking device 10b. Thus, the user can apply a force to the first housing 40 for the vibration absorbing locking device 10b to slide within the first slot 60a along the y-direction and separate the first housing 40 from the second housing 60. The first housing 40 can be a hard disc housing or an optical disc drive housing, the second housing 60 can be a computer housing, and the electronic device 70 can be a computer for instance.

### Fourth Embodiment

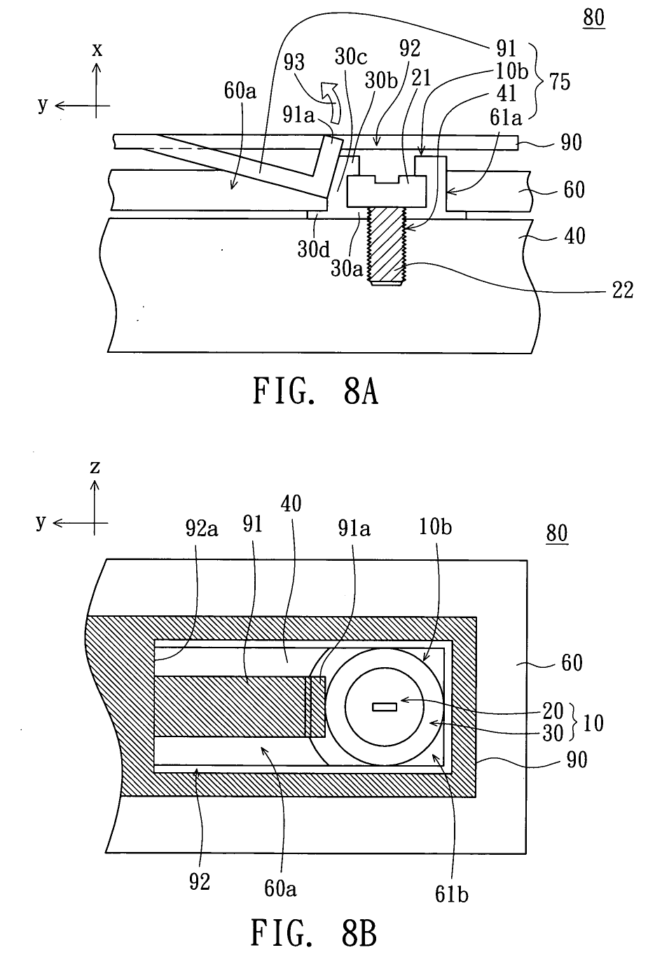

Referring to FIGS. 8A˜8B, two partially enlarged cross-sectional views of an electronic device having a locking assembly device according to a fourth embodiment of the invention are shown. The electronic device 80 of the present embodiment differs with the electronic device 50 of the second embodiment in the locking assembly device 75, and in that the electronic device 80 has an extra a third housing 90 than the electronic device 50. The locking assembly device 75 has an extra positioning element 91 than the locking assembly device 55 of the second embodiment. In FIGS. 8A˜8B, the third housing 90 is mounted on the second housing 60, so that the second housing 60 is positioned between the first housing 40 and the third housing 90, and that the third housing 90 has an aperture 92 corresponding to the first slot 60a. The extending direction of the aperture 92 is the same with the extending direction of the first slot 60a. The positioning element 91 extends and tilts towards the first slot end 61 b from an aperture wall 92a of the aperture 92 along the extending direction of the aperture 92. When the vibration absorbing locking device 10b slides to the first slot end 61b, another end of the positioning element 91 is for pressing the vibration absorbing locking device 10b at the first slot end 61b, such as pressing the top portion 30b and the vertical portion 30c for instance, so that the first housing 40 and the second housing 60 are correspondingly positioned and coupled together.

In the present embodiment of the invention, apart from coupling the first housing 40 and the second housing 60 and preventing the first housing 40 and the second housing 60 from vibrating when receiving an external force, the locking assembly device 75 can further enable the first housing 40 and the second housing 60 to be correspondingly positioned when the positioning element 91 presses the vibration absorbing locking device 10b at the first slot end 61b.

Besides, the positioning element 91 can be a bendable material, a spring, an elastic piece or a combination of a spring and an elastic piece for instance. Furthermore, the positioning element 91 and the third housing 90 can be integrally formed into an integral body. Another end of the positioning element 91, which can be a bending 91 a for instance, is convenient for the user to grab at hand and apply a force along the direction of the arrow 93 to move and separate the positioning element 91 from the vibration absorbing locking device 10b. Or, the positioning element 91 can be separated from the vibration absorbing locking device 10b when the user dismount the third housing 90 from the second housing 60 directly. Thus, the user can apply a force to the first housing 40 for the vibration absorbing locking device 10b to slide within the first slot 60a along the y-direction and separate the first housing 40 from the second housing 60. The first housing 40 can be a hard disc housing or an optical disc drive housing, the second housing 60 can be a computer housing, and the electronic device 80 can be a computer for instance.

According to the shockproof locking assembly device disclosed in the above embodiments of the invention, the incorporation of the slot, the hole and the vibration absorbing locking device not only enables a first housing having the hole to be coupled to and slide with respect to a second housing having the slot, but also prevents the first housing and the second housing from vibrating when receiving an external force. Thus, the assembly time of the first housing and the second housing is reduced, and the tightness and shockproof between the first housing and the second housing are largely enhanced. Besides, the design of intruding a positioning element to the locking assembly device of the embodiment presses the vibration absorbing locking device at one end of the slot so that the first housing and the second housing are correspondingly positioned and secured accordingly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A shockproof locking assembly device, comprising:
a hole;
a slot; and
a vibration absorbing locking device, comprising:
a locking element, comprising:
a head portion; and
a shaft portion which extends from the head portion for locking into the hole; and
a vibration absorbing element which encompasses part of the locking element for the shaft portion to penetrate the vibration absorbing element, wherein the vibration absorbing element penetrates the slot.

2. The shockproof locking assembly device according to claim 1, further comprising:
a positioning element which extends towards an end of the slot along the slot for pressing the vibration absorbing locking device at the end of the slot.

3. The shockproof locking assembly device according to claim 1, the hole being formed on a first housing, the slot being formed on a second housing, wherein the vibration absorbing element further comprises:
a rib portion which encompasses a peripheral lateral side of the bottom portion of the vibration absorbing element and is positioned between the surface of the first housing and that of the second housing.

4. The shockproof locking assembly device according to claim 3, further comprising:
a positioning element which is disposed on the second housing and extends towards an end of the slot along the slot for pressing the vibration absorbing locking device at the end of the slot.

5. The shockproof locking assembly device according to claim 3, the second housing being connected to a third housing and positioned between the first housing and the third housing, the third housing having an aperture corresponding to the slot, wherein the locking assembly device further comprises:
a positioning element which extends and tilts towards an end of the slot from an aperture wall of the aperture along the extending direction of the aperture for pressing the vibration absorbing locking device at the end of the slot.

6. A vibration absorbing element mounted on a locking element, wherein the locking element comprises a head portion and a shaft portion, the head portion has a first surface and a second surface opposite to each other, an end of the shaft portion is connected to part of the second surface, and the vibration absorbing element comprises:
a bottom portion having a bottom aperture for receiving the end of the shaft portion for most part of the shaft portion to be projected from the bottom portion;
a top portion having a top aperture for exposing part of the first surface; and
a vertical portion having a chamfer being adjacent to the bottom aperture and the top aperture for connecting the bottom portion and the top portion, wherein the chamfer is for receiving the head portion.

7. The vibration absorbing element according to claim 6, further comprising:
a rib portion which encompasses the bottom portion and is disposed on a peripheral lateral side of the bottom portion.

8. The vibration absorbing element according to claim 7, wherein the bottom portion, the top portion, the vertical portion and the rib portion are integrally formed into an integral body.
